(19) United States
(12) Patent Application Publication
(10) Pub. No.: US 2022/0184546 A1
(43) Pub. Date: Jun. 16, 2022

(54) CARBON-CAPTURE DEVICES AND METHOD

(71) Applicant: Eric T. Miller, Sicklerville, NJ (US)

(72) Inventor: Eric T. Miller, Sicklerville, NJ (US)

(21) Appl. No.: 17/507,978

(22) Filed: Oct. 22, 2021

Related U.S. Application Data
(60) Provisional application No. 63/126,107, filed on Dec. 16, 2020.

(51) Int. Cl. B01D 53/04; B01D 53/62; B01D 35/143

(52) U.S. Cl. CPC B01D 53/0407; B01D 53/62; B01D 35/143; B01D 2201/0461; B01D 2251/604; B01D 2258/01; B01D 2201/0415; B01D 2257/504

(57) ABSTRACT

A device for scrubbing carbon molecules from the ambient atmosphere includes a housing, a carbon-capture filter, and a holding mechanism to hold the device in operable association with an automobile. A housing may be perforated and constructed to removably hold a filter. A filter can include a hydroxide chemical compound in granular form. A holding mechanism may anchor the device to a grille, under-hood element, or in operable association with a tailpipe of an automobile. Sometimes, the device includes a color-changing indicator to indicate end-of-life of a filter. A decorative emblem may be included to obscure the device from casual observation by a passerby.

### RELATED APPLICATIONS

This application claims the benefit under 35 U.S.C. 119(e) of the filing date of Provisional Application Ser. No. 63/126,107, filed Dec. 16, 2020, for “CARBON-CAPTURING DEVICES”, the entire content of which is incorporated in this disclosure as though set forth herein in its entirety.

### BACKGROUND

### Field of the Invention

This invention relates to devices for removing carbon from an ambient atmosphere environment and removing of carbon directly from automotive tailpipes.

### State of the Art

This invention has been inspired by the process of neutralization of the carbon dioxide that a patient produces during anesthesia. To understand how and why anesthesia provides an answer to climate change, it is important to understand that human beings and automobiles “breathe” the same atmosphere and consume the same oxygen to make energy. The end result of this energy-producing process is carbon dioxide.

When a human being is placed under general anesthesia, they are usually chemically, temporarily paralyzed. Because of this, their breathing must be controlled by a mechanical ventilator. Then, oxygen is pumped into their bodies from this ventilator. Because the patient under general anesthesia is still alive, they use the oxygen that is given to them to produce energy. This energy production, which is derived via biochemistry and cellular respiration, leaves the end product of carbon dioxide. This carbon dioxide is exhaled by the same mechanical ventilator. But the patient cannot rebreathe carbon dioxide. If they did, it would be fatal. This means that during general anesthesia, the patient's carbon dioxide must be neutralized. This is accomplished with the attachment of a hydroxide filter. This filter is attached to the artificial ventilator. And, chemically speaking, the hydroxide filter traps carbon dioxide before the patient rebreathes their own poisonous gas.

When an automobile is started, it too, like human beings, takes in oxygen because, as stated, human beings and automobiles “breathe” the same atmosphere. The automobile burns oxygen to create force with gasoline, to drive the internal pistons of an internal combustion engine. These gases that are produced are funneled down through the engines exhaust systems and converted to carbon dioxide (and other trace gases), once they are downstream of the catalytic converter. Because the carbon dioxide produced by automobiles is the exact same carbon dioxide produced by human beings, the principles of anesthesia can be used to neutralize carbon dioxide from an automobile and help solve climate change.

There are existing devices with similar functions, but they are not mass-produced nor readily available because (1) they are big, bulky, expensive, and tend to look as if they aren't a part of the car; and (2), there is no easy way to change the hydroxide filter once the reactants are exhausted.

The current invention addresses the current shortcomings and has the advantage of a color indicator. The hydroxide filter used in the present invention uses a color indicator to let the driver know when it's time to change the filter. After a set time, the driver can check the indicator and replace the filter by themselves.

Furthermore, devices with similar functions are typically available as a whole attachment, without the possibility of replacing only the filter. The present invention may be embodied in many configurations, including as a tailpipe attachment and an attachment for the front of a car. In any case, a housing portion need be purchased only once, and then the hydroxide filters can be replaced cheaply and easily. Additionally, embodiments can use the same filter.

Finally, there are no available products that actually attach to a car and remove carbon dioxide from the atmosphere as the driver actually drives the car. An embodiment configured for attachment to the front of a car could potentially be attached to a fully electric car, which would create the first negative carbon emissions automobile in human history.

### BRIEF SUMMARY OF THE INVENTION

An embodiment constructed according to certain principles of this invention provides a device for chemically scrubbing carbon molecules from an ambient air environment. One workable embodiment includes a housing, a removable carbon-capture filter disposed inside the housing, and a holding mechanism associated with the housing to hold the housing in installed registration with an automobile. The invention may also be embodied in a method of use of such a device.

A workable housing is configured and arranged to carry a removable and replaceable carbon-capture filter. A preferred housing is porous to permit ingress of ambient air for contact with the filter. A wall of a porous housing may include a plurality of apertures spaced apart around a housing perimeter and spaced apart along a housing length axis.

A preferred housing includes a generally cylindrical body with a first removable end cap couplable to one end of the body, and a second end cap affixed to the other end of the body. In one such case, the body may carry a threaded portion at one end to engage with a cooperating threaded portion of the first end cap. Desirably, at least one end cap is porous to permit flow of air there-through. In one embodiment, at least one end cap comprises a reducing bushing to reduce an inside diameter of the body to a smaller diameter at an ambient air passage, the smaller diameter to resist egress of the filter from installed registration inside the housing. Sometimes a housing includes a housing flange disposed transversely with respect to a body length axis. Such a flange can carry a first anchor of a holding mechanism.

One workable holding mechanism may be biased, including spring-biased, to hold onto a portion of the automobile. Other workable holding mechanisms may be adhesively-bonded, welded, or bolted to a portion of an automobile. Certain holding mechanisms may include a theft-deterrent construction. One embodiment of a holding mechanism includes a spring-biased element associated with a clamping member, the clamping member being configured to couple with a portion of the automobile. An operable clamping member may include a band clamp. Another operable clamping member includes a hinged jaw. One workable holding mechanism can be configured and arranged to couple with a grille of a commercially available automobile. Another workable holding mechanism may be configured and arranged to couple with the exhaust pipe of a commercially available automobile.

A currently preferred holding mechanism includes a band clamp and a plurality of tension coil springs. The band clamp is configured to engage with an outside circumference of a tailpipe of an automobile. One end of each spring element is anchored to the band clamp, and the springs' opposite ends are associated in some way with a housing to urge a portion of the housing into installed registration inside the tailpipe. In the preferred embodiment, springs' opposite ends are anchored to apertures in a transverse body flange.

A workable carbon-capture filter is operable to chemically scrub carbon molecules from an ambient air environment. Certain filter embodiments include a hydroxide chemical compound in granular form. Preferably, the filter is removable from the housing, sometimes in a tool free operation. In certain cases, an embodiment may include a color-changing indicator associated with the filter to visually indicate end-of-life for the filter.

It is within contemplation that embodiments may include a decorative emblem coupled to the housing and disposed to block direct casual view of a portion of the housing by a passerby. Certain emblems may be perforated to facilitate flow of ambient air there-through.

The invention may be embodied in a method including the steps of: providing a housing to hold a carbon-capture filter, the housing to hold the filter in installed registration with respect to structure of a commercially available automobile, the housing being porous to facilitate flow of ambient air for contact with an installed filter; providing a plurality of carbon-capture filters, each filter comprising at least one hydroxide compound in granular form and a color-changing end-of-life indicator; instructing a user to install the housing in registration with the automobile; instructing the user to place a first filter into operable registration with respect to the installed housing; instructing the user to periodically inspect the end-of-life indicator of the first filter; and instructing the user to replace the first filter with a second filter subsequent to observing a color change indicating end-of-life of the first filter. In certain cases, the step of instructing a user to install the housing includes one of: instructing the user to associate the housing with a tailpipe of the automobile; instructing the user to associate the housing with a grille element of the automobile; or, instructing the user to dispose the housing under the hood of the automobile.

A currently most preferred embodiment includes a housing with a generally cylindrical body with a first blocking element couplable to one end of the body and a second blocking element affixed to the other end of the body. Sometimes, both blocking elements are removable from the body. Workable first and second blocking elements are configured to resist unintended egress of an installed carbon-capture filter from inside the body. Desirably, the body is porous to facilitate circulation of ambient air through the body and still resist egress of an installed carbon-capture filter. The carbon-capture filter typically includes a hydroxide chemical compound in granular form to chemically scrub carbon molecules from the ambient air environment. A color-changing indicator may be associated with the filter to indicate end-of-life for the filter.

The preferred embodiment also includes a holding mechanism to hold the filter in operable association with an automobile. The currently preferred holding mechanism includes a band clamp for engagement with an outside circumference of a tailpipe of the automobile, and a plurality of elongate tension coil spring elements anchored at distal spring ends to the band clamp with the proximal spring ends being anchored in some fashion to the housing to urge a distal portion of the housing into installed registration inside the tailpipe. One operable anchor arrangement at the housing includes a transverse housing flange with a plurality of perforations. Proximal ends of stretched tension springs may be affixed to such perforations to urge the housing toward the band clamp, and simultaneously urge the distal end of the housing into registration inside the exhaust pipe.

### BRIEF DESCRIPTION OF THE DRAWINGS

In the drawings, which illustrate what are currently considered to be the best modes for carrying out the invention and in which like structure is identified by like numerals, and primes are used to indicate alternative representations of like structure:

FIG. 1 is a perspective view of an embodiment according to certain principles of the invention installed on an automobile;

FIG. 2 through 5 are views from various perspectives of the embodiment in FIG. 1;

FIG. 6 is a plan view of a body flange portion of the embodiment in FIG. 1;

FIG. 7 is a perspective view of a workable carbon-capture filter;

FIG. 8 is a side view of the filter in FIG. 7, partially assembled;

FIG. 9 is an end view in perspective of another embodiment according to certain principles of the invention, in assembled position on an automobile;

FIG. 10 is a side view in perspective of the embodiment in FIG. 9;

FIG. 11 is a plan view of a body flange portion of the embodiment in FIG. 9;

FIGS. 12 and 13 are plan views of operable variations of portions of holding mechanisms;

FIGS. 14 and 15 are views in different perspectives of another embodiment according to certain principles of the invention, in assembled position on an automobile;

FIGS. 16 and 17 are views in different perspectives of constituent elements of the embodiment in FIGS. 14 and 15;

FIG. 18 is a fish-eye perspective side view of a housing portion of the embodiment in FIGS. 14 and 15;

FIG. 19 is a perspective view of end cap portions of the housing in FIG. 18;

FIG. 20 is a perspective view of clamp linkage from the embodiment in FIGS. 14 and 15;

FIG. 21 is a perspective view of spring-biased clamp elements from the embodiment in FIGS. 14 and 15;

FIG. 22 is a side view of the embodiment in FIGS. 14 and 15, partially assembled;

FIGS. 23 and 24 are views in different perspectives of a clamp linkage from the embodiment in FIGS. 14 and 15; and

FIG. 25 is a perspective view of the embodiment in FIGS. 14 and 15, further assembled;

FIGS. 26 and 27 are views in different perspectives of a decorative emblem assembly from the embodiment in FIGS. 14 and 15; and

FIG. 28 is a side view in perspective of the embodiment in FIGS. 14 and 15.

### DETAILED DESCRIPTION OF THE ILLUSTRATED EMBODIMENTS

Reference will now be made to the drawings in which the various elements of the illustrated embodiments will be given numerical designations and in which the invention will be discussed so as to enable one skilled in the art to make and use the invention. It is to be understood that the following description is only exemplary of certain principles of the present invention, and should not be viewed as narrowing the claims which follow. Embodiments according to certain principles of the invention may be embodied in many, many ways other than those illustrated.

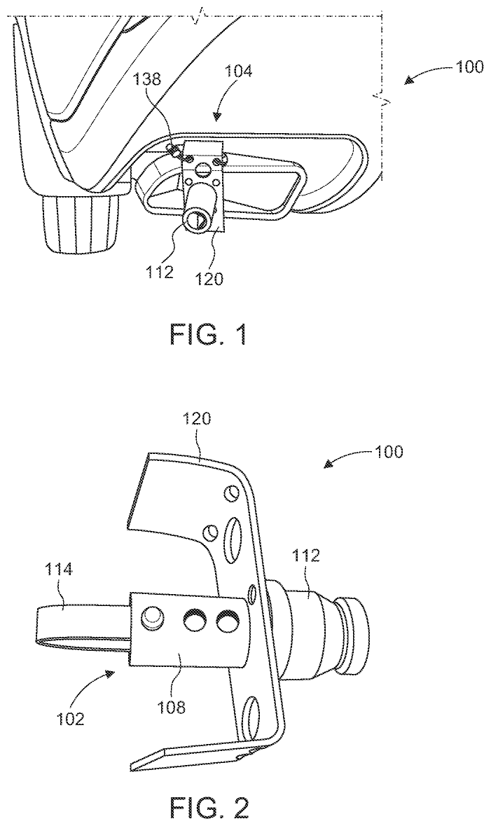

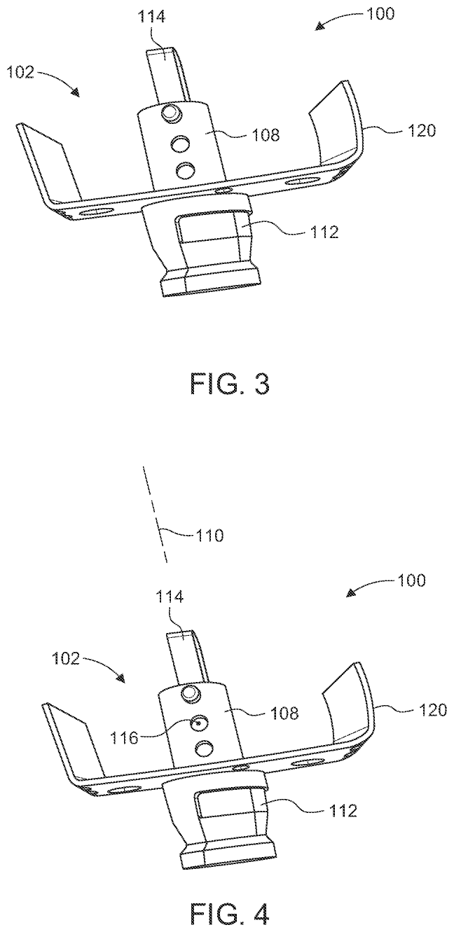

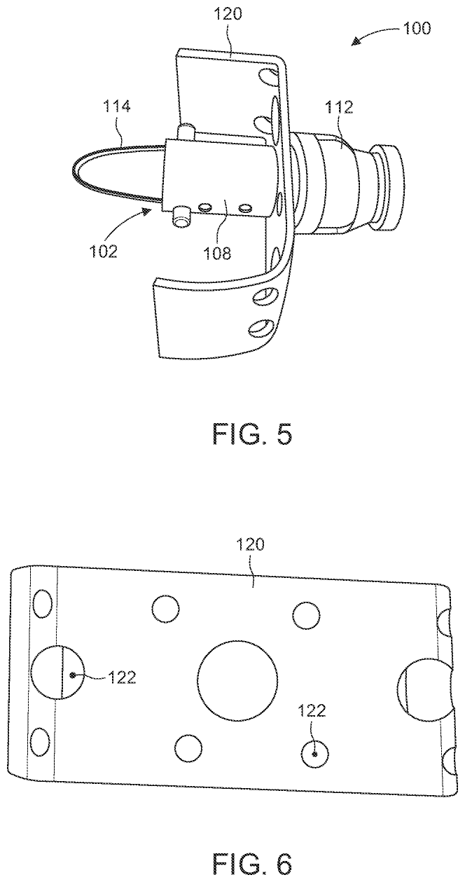

An embodiment of a carbon-capture device constructed according to certain principles of the invention is illustrated generally at 100 in FIG. 1. Embodiment 100 is structured to couple with the tail pipe of an automobile. With reference to FIGS. 1 through 8, capture device 100 includes a housing, generally 102, a holding mechanism, generally 104, and a carbon-capture filter, generally 106.

A workable housing 102 may include a hollow body 108 that is generally cylindrical and extends along a body length axis 110. A first end cap 112 is affixed to a proximal end of body 108. A second end cap 114 is affixed at the distal end of body 108. At least one of end caps 112 and 114 are removable from body 108 to permit installing and removing a filter 106.

Desirably, a housing 108 is porous to facilitate entrance of air for contact between ambient air and the filter 106. With particular reference to FIG. 4, a plurality of apertures 116 may be disposed in penetration through a wall of body 108 to facilitate such air flow.

An end cap may also be porous to admit flow of ambient air. In e.g., FIGS. 1 and 4, it may be seen that end cap 112 is configured as a reducing bushing that is threaded onto the proximal end of body 108. The proximal end of cap 112 in e.g., FIG. 1, is open to the atmosphere, but its reduced-end opening is sufficiently small in diameter to resist undesired escape of an installed filter 106.

Embodiments according to certain principles of the invention may include a body flange 120. A workable flange 120 may be disposed substantially perpendicular to the body length axis 110. An exemplary flange 120 provides a structurally interfering stop to control depth of insertion of a distal end of body 108 into a tailpipe. Further, a flange 120 may provide an anchor for a portion of a holding mechanism 104 to maintain the body 108 in registration with an automobile. Typically, a plurality of apertures 122 are provided to resist restriction of flow of automobile exhaust by the flange 120.

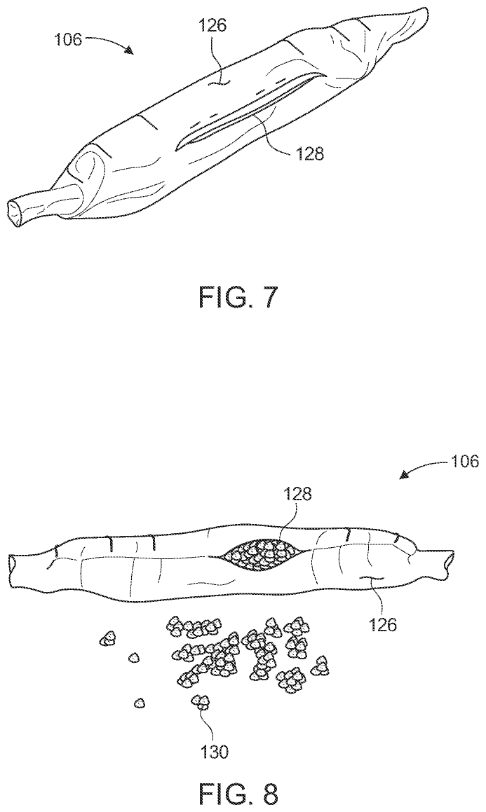

With reference now to FIGS. 7 and 8, a workable filter 106 may be made by rolling up a cylinder of a porous wall membrane 126 to confine a quantity of carbon-scrubbing chemical compound there-in. A side wall opening 128 may sometimes be provided, and can be closed by stapling or other known means subsequent to filling the interior with a carbon-scrubbing active agent. A currently preferred scrubbing agent includes a hydroxide chemical compound 130 in granular form. Preferably, the wall 126 is configured to provide sufficient transparency to permit a user to view the confined compound 130. A workable wall may be constructed from woven stainless steel wire mesh. It is within contemplation that the granules of compound 130 may inherently provide a color indicator for their end-of-life. For example, virgin granules 130 of calcium or sodium hydroxide are white, and spent granules 130 are violet.

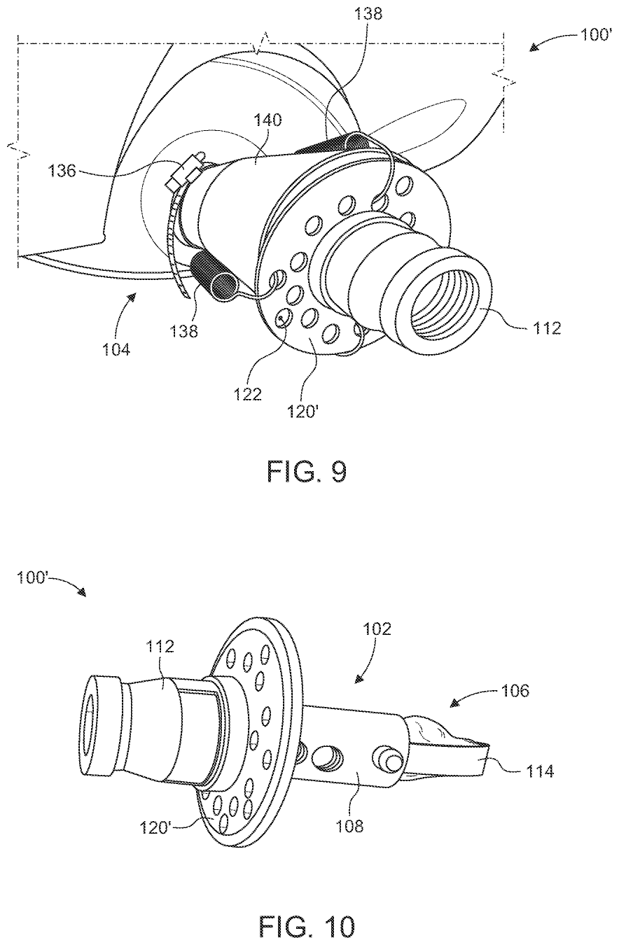

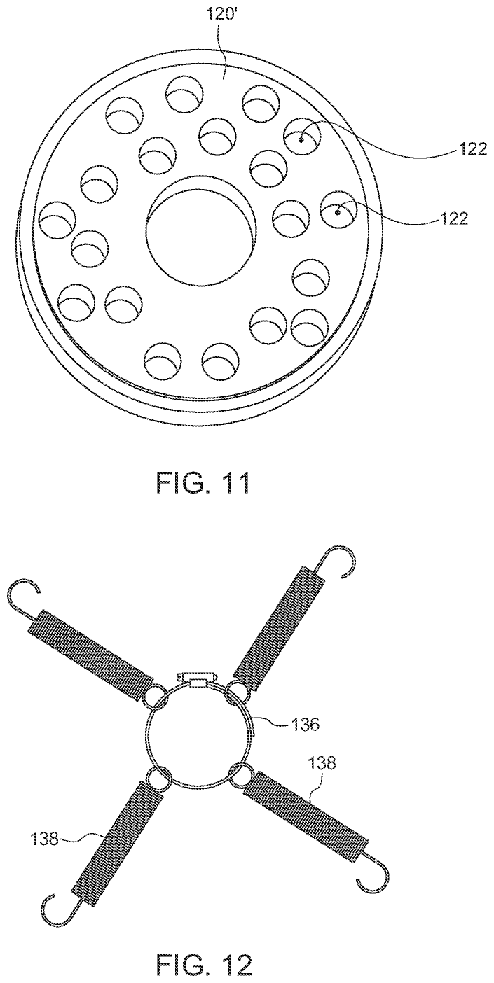

Another embodiment of a carbon-capture device constructed according to certain principles of the invention is illustrated generally at 100′ in FIG. 9. Embodiment 100′ is also structured to couple with the tail pipe of an automobile. With reference to FIGS. 9 through 13, capture device 100′ includes a housing, generally 102, a holding mechanism, generally 104, and a carbon-capture filter, generally 106.

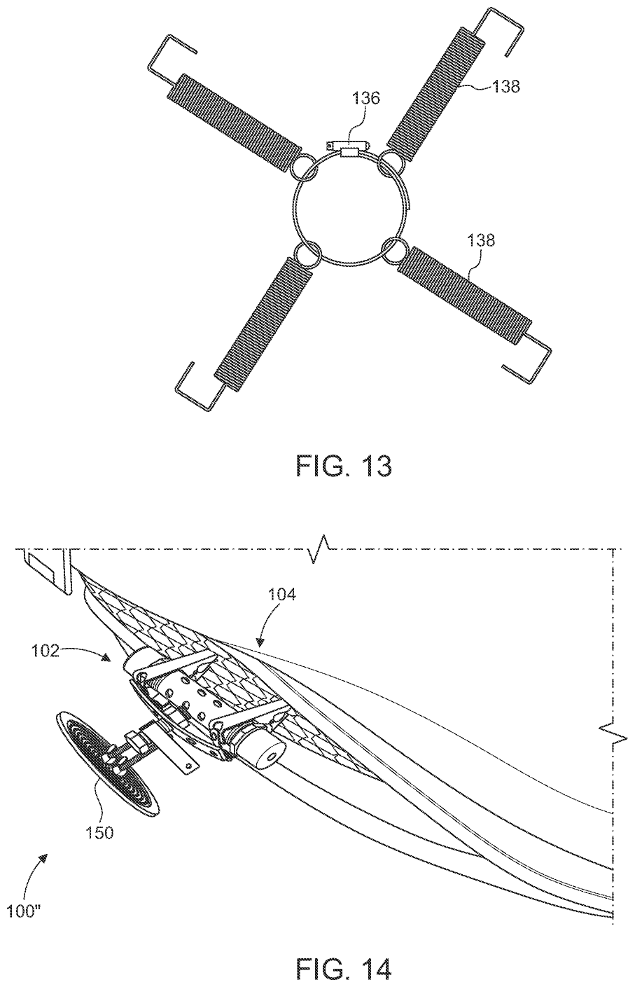

As seen in FIG. 9, an exemplary holding mechanism 104 includes a band clamp 136 and a plurality of tension coil springs 138. Band clamp 136 may be snugged into circumferential engagement with the exhaust pipe of the automobile to provide a remote anchor location. As illustrated, a distal end of a spring 138 may be anchored remotely at the band clamp 136. A proximal end of a stretched spring 138 can conveniently be anchored in registration with a flange aperture 122, or other structure associated with a body 108. Consequently, the distal end of body 108 is urged into a held and installed registration inside the exhaust pipe 140 by action of the holding mechanism 104. With reference to FIGS. 12 and 13, proximal ends of spring elements 138 may be configured as desired to interface in cooperation with flanges 120 or bodies 108 having different construction.

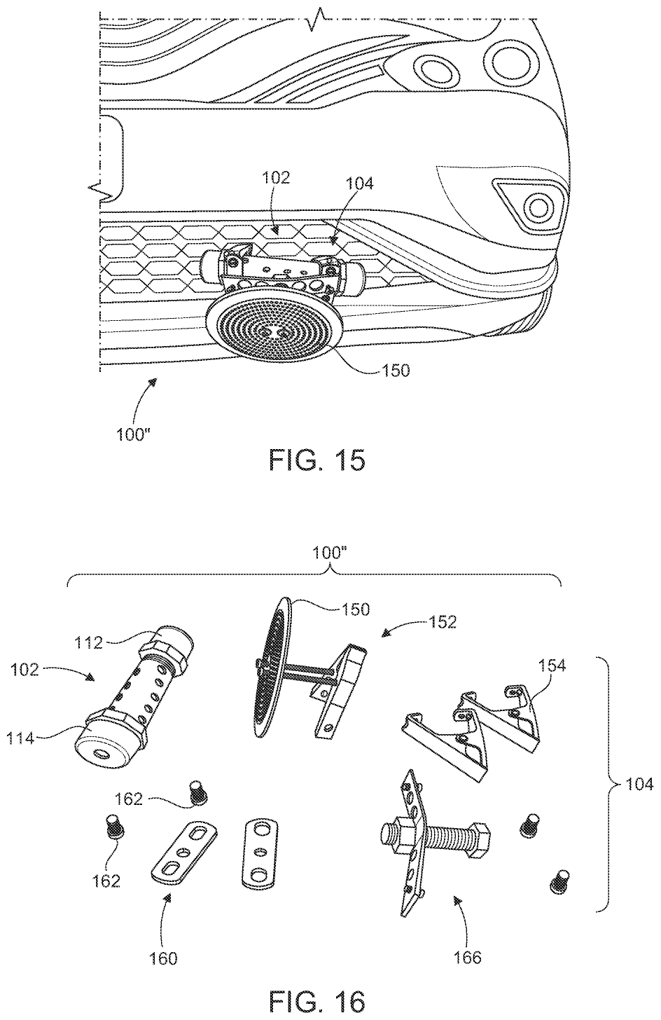

Another embodiment of a carbon-capture device constructed according to certain principles of the invention is illustrated generally at 100″ in FIGS. 14 through 17, and 28. Embodiment 100″ is configured to couple with the grille of an automobile. Carbon capture device 100″ includes a housing, generally 102, a holding mechanism, generally 104, and a carbon-capture filter, generally 106 (see e.g., FIGS. 7 and 8).

Sometimes, an embodiment according to certain principles of the invention may include a decorative emblem 150. In embodiment 100″, an exemplary emblem 150 is configured to block direct casual view of a portion of the housing by a passerby. Further, a preferred emblem 150 is perforated to facilitate flow of ambient air there-through.

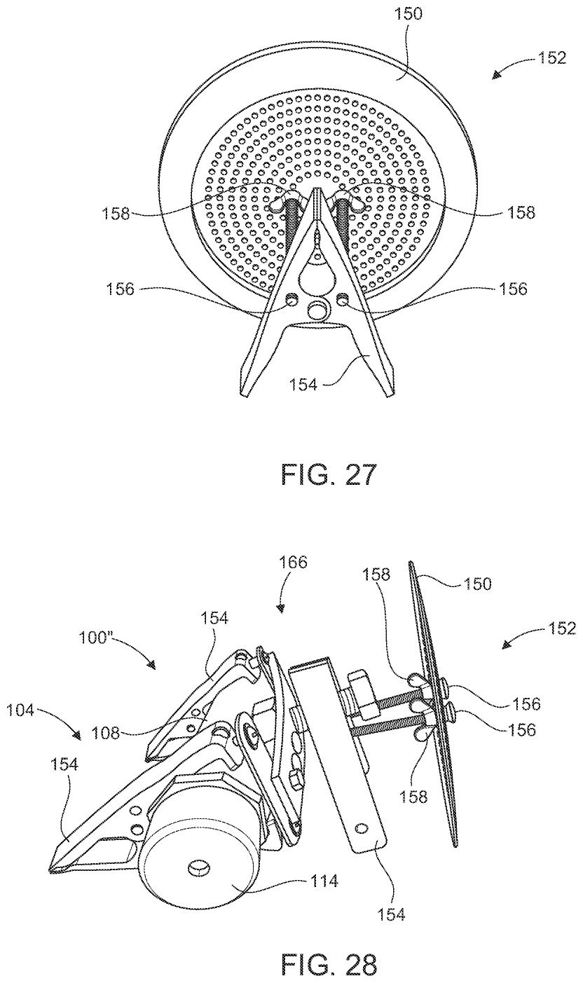

With reference to FIGS. 26 and 27, the illustrated exemplary emblem 150 is carried in an assembly, generally 152. Assembly 152 includes a spring clamp 154, bolt 156, and wing nut 158. The clamp, bolt, and wing nut are merely exemplary of workable connection elements.

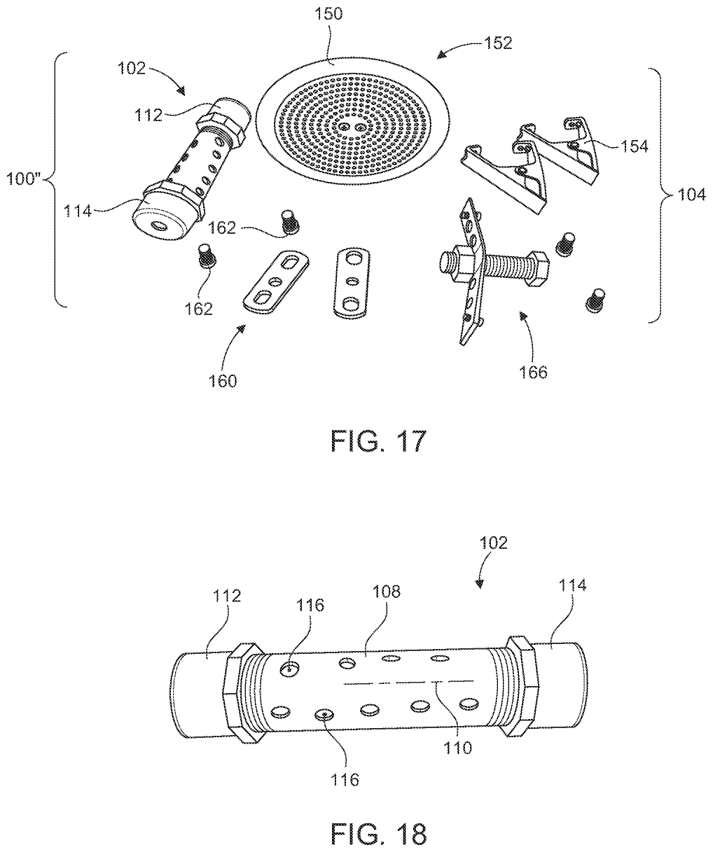

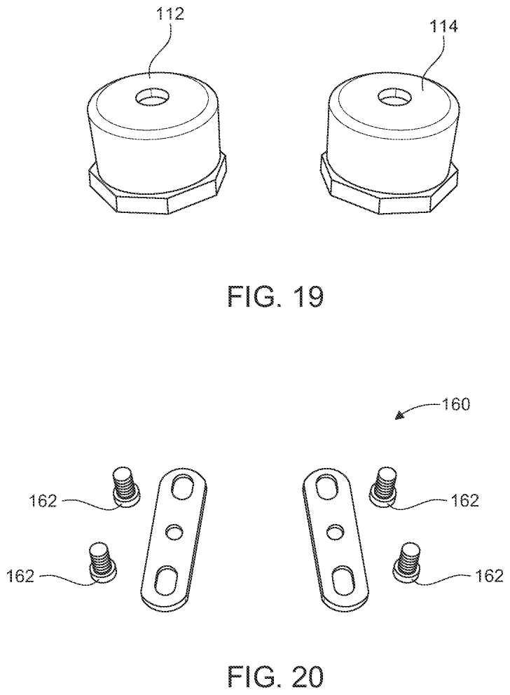

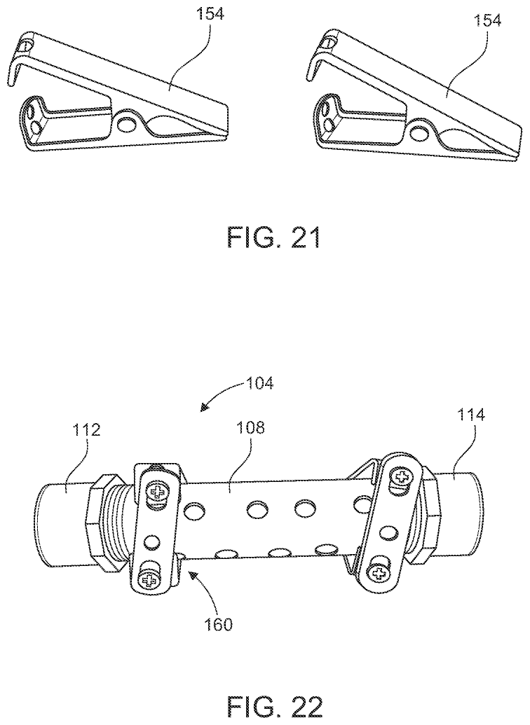

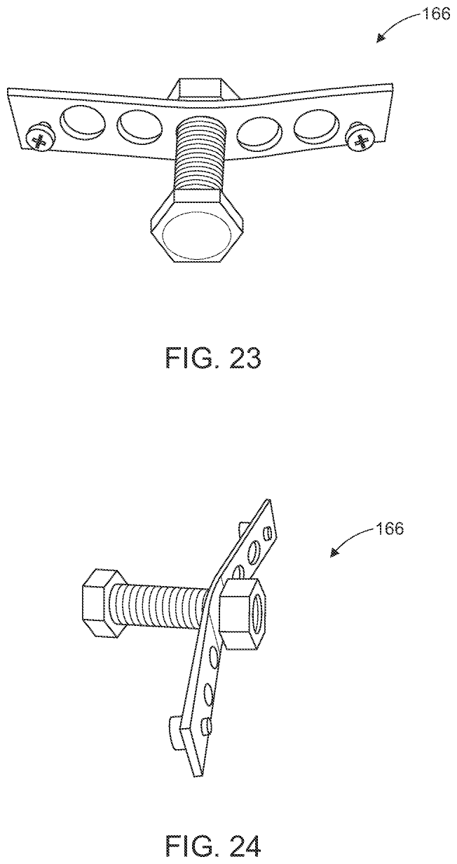

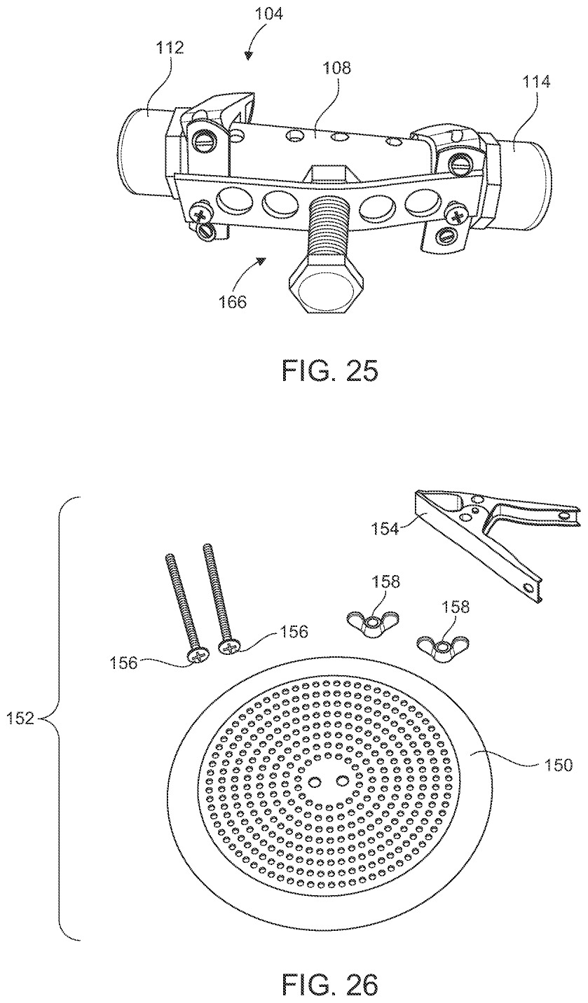

With reference to FIGS. 16 and 17, a workable holding mechanism 104 may include a spring-biased clamp 154, and a theft-resistant linkage, generally 160. Linkage 160 is installed in registration at the terminal handle ends of an installed clamp 160 by way of bolts 162. A hinged jaw element of a clamp 154 is workable to hold onto a portion of an automobile to anchor a device 100″ in operable position. An end cap can be removed from the housing body 108, to permit the body to slide in a length axis direction between handle portions of the installed clamp 154. Reassembly of the end cap causes the housing 102 to remain in an installed position with respect to an automobile. Consequently, clamp 154 cannot then be actuated due to presence of the body 108, and the linkage 160. Removal of bolts 162 of an installed clamp 154 reasonably requires use of tools, and thereby offers a measure of theft resistance. A stand-off, generally 166, may be affixed to a clamp linkage 160 to serve as an anchor for emblem assembly 152.

With reference now to FIG. 18, a body 108 may include apertures disposed spaced apart around a body perimeter, and spaced apart along a body length axis. Opposite ends of the body 108 may be threaded to receive cooperating end caps 112 and 114. Preferably, an endcap will be perforated to facilitate flow of air into the body 108 for contact of air to the carbon-capture filter 106. Many other ways to construct and assemble a workable end cap to a body will occur to one of ordinary skill.

While aspects of the invention have been described in particular with reference to certain illustrated embodiments, such is not intended to limit the scope of the invention. The present invention may be embodied in other specific forms without departing from its spirit or essential characteristics. For one example, one or more element may be extracted from one described or illustrated embodiment and used separately or in combination with one or more element extracted from one or more other described or illustrated embodiment(s), or in combination with other known structure. The described embodiments are to be considered as illustrative and not restrictive. Obvious changes within the capability of one of ordinary skill are encompassed within the present invention. All changes which come within the meaning and range of equivalency of the claims are to be embraced within their scope.

What is claimed is:

1. An apparatus, comprising:
a housing configured and arranged to carry a removable and replaceable carbon capture filter;
the removable carbon capture filter, the filter to chemically scrub carbon molecules from an ambient air environment; and
a holding mechanism associated with the housing to hold the housing in installed registration with an automobile.

2. The apparatus according to claim 1, further comprising:
a color-changing indicator associated with the filter to visually indicate end-of-life for the filter.

3. The apparatus according to claim 1, further comprising:
a decorative emblem coupled to the housing and disposed to block direct casual view of a portion of the housing by a passerby, the emblem being perforated to facilitate flow of ambient air there-through.

4. The apparatus according to claim 1, wherein:
the housing is porous to permit ingress of ambient air for contact with the filter.

5. The apparatus according to claim 4, wherein:
a wall of the housing comprises a plurality of apertures spaced apart around a housing perimeter and spaced apart along a housing length axis.

6. The apparatus according to claim 4, wherein:
the housing comprises a generally cylindrical body with a first removable end cap couplable to one end of the body, and a second end cap affixed to the other end of the body.

7. The apparatus according to claim 6, wherein:
the body carries a threaded portion to engage with a cooperating threaded portion of the first end cap.

8. The apparatus according to claim 6, wherein:
at least one end cap is porous to permit flow of air there-through.

9. The apparatus according to claim 6, wherein:
at least one end cap comprises a reducing bushing to reduce an inside diameter of the body to a smaller diameter at an ambient air passage, the smaller diameter to resist egress of the filter from installed registration inside the housing.

10. The apparatus according to claim 4, wherein:
the housing comprises a flange disposed transversely with respect to a body length axis, the flange carrying a first anchor structure of the holding mechanism.

11. The apparatus according to claim 1, wherein:
the holding mechanism is spring-biased to hold onto a portion of the automobile, and comprises a theft-deterrent construction.

12. The apparatus according to claim 1, wherein:
the holding mechanism comprises a spring-biased element associated with a clamping member, the clamping member to couple with a portion of the automobile.

13. The apparatus according to claim 12, wherein:
the clamping member comprises a band clamp.

14. The apparatus according to claim 12, wherein:
the clamping member comprises a hinged jaw element.

15. The apparatus according to claim 1, wherein:
the holding mechanism is configured and arranged to couple with a grille of a commercially available automobile.

16. The apparatus according to claim 1, wherein:
the holding mechanism is configured and arranged to couple with the exhaust pipe of a commercially available automobile.

17. The apparatus according to claim 16, wherein:
the holding mechanism comprises:
a band clamp for engagement with an outside circumference of a tailpipe of the automobile; and
a plurality of spring elements anchored to the band clamp at one end with the opposite end being associated with the housing to urge a portion of the housing into installed registration inside the tailpipe.

18. A method, comprising:
providing a housing to hold a carbon capture filter, the housing to hold the filter in installed registration with respect to structure of a commercially available automobile, the housing being porous to facilitate flow of ambient air for contact with an installed filter;
providing a plurality of carbon capture filters, each filter comprising at least one hydroxide compound in granular form and a color-changing end-of-life indicator;
instructing a user to install the housing in registration with the automobile;
instructing the user to place a first filter into operable registration with respect to the installed housing;
instructing the user to periodically inspect the end-of-life indicator of the first filter; and
instructing the user to replace the first filter with a second filter subsequent to observing a color change indicating end-of-life of the first filter.

19. The method according to claim 18, wherein the step of instructing a user to install the housing comprises one of:
instructing the user to associate the housing with a tailpipe of the automobile;
instructing the user to associate the housing with a grille element of the automobile; or
instructing the user to dispose the housing under the hood of the automobile.

20. An apparatus, comprising:
a housing comprising a generally cylindrical body with a first blocking element couplable to one end of the body and a second blocking element affixed to the other end of the body, the first and second blocking elements to resist unintended egress of an installed carbon capture filter from inside the body, the body being porous to facilitate circulation of ambient air through the body;
the filter comprising a hydroxide chemical compound in granular form to chemically scrub carbon molecules from an ambient air environment;
a color-changing indicator associated with the filter to indicate end-of-life for the filter; and
a holding mechanism comprising:
a band clamp for engagement with an outside circumference of a tailpipe of the automobile; and
a plurality of elongate coil tension spring elements anchored at one spring end to the band clamp with the opposite spring end being associated with the housing to urge a portion of the housing into installed registration inside the tailpipe.
